(19) United States
(12) Patent Application Publication
(10) Pub. No.: US 2014/0379928 A1
(43) Pub. Date: Dec. 25, 2014

(54) METHOD FOR IMPLEMENTING NETWORK USING DISTRIBUTED VIRTUAL SWITCH, APPARATUS FOR PERFORMING THE SAME, AND NETWORK SYSTEM BASED ON DISTRIBUTED VIRTUAL SWITCH

(71) Applicant: ELECTRONICS & TELECOMMUNICATIONS RESEARCH INSTITUTE, Daejeon (KR)

(72) Inventors: Jong Tae SONG, Daejeon (KR); Kyung Gyu CHUN, Daejeon (KR)

(21) Appl. No.: 14/313,129

(22) Filed: Jun. 24, 2014

(30) Foreign Application Priority Data
Jun. 24, 2013 (KR) 10-2013-0072212

(51) Int. Cl. H04L 29/08

(52) U.S. Cl. CPC H04L 67/1006
USPC 709/226

(57) ABSTRACT

Disclosed are a method for implementing a network using a distributed virtual switch, an apparatus performing the same, and a network system based on the distributed virtual switch. A method for implementing a network using a distributed virtual switch comprises implementing network control functions as a plurality of virtual machines; grouping the plurality of virtual machines into several groups according a preconfigured policy; and implementing at least one virtual machine belonging to a same group in a same server having a virtualization structure based on a distributed virtual switch. Thus, a mobile communication network may be implemented flexibly and efficiency of operating the network may be enhanced.

### CLAIM FOR PRIORITY

This application claims priority to Korean Patent Application No. 10-2013-0072212 filed on Jun. 24, 2013 in the Korean Intellectual Property Office (KIPO), the entire contents of which are hereby incorporated by references.

### BACKGROUND

1. Technical Field

Example embodiments of the present invention relate to a technology for network implement, and more specifically to a method for implementing a network using distributed virtual switches which can implement network control functions flexibly, a network apparatus performing the same, and a network system based distributed virtual switches.

2. Related Art

Conventional mobile communication networks generally comprise control plane function entities responsible for control signaling and data plane function entities responsible for data forwarding.

The control plane function entities perform signaling for exchanging control information between the entities in order to perform resource controls for service configuration, authentication on user and terminals, charging, etc.

On the other hand, the signaling functions performed in the conventional mobile communication network are implemented as distributed in locations identical to installation positions of network apparatuses performing the corresponding functions, and control functions performed by the control plane function entities are implemented as performed in at least one server.

Therefore, communications between the entities are performed via a network, and so there become various shortcomings.

For example, since functions of network apparatuses and physical environmental factors such as installation positions of network apparatuses should be considered, flexibility in network implementation may be reduced. Also, since function entities are distributed in the network, overheads for guaranteeing data integrity and for maintaining confidentiality are additionally required. Also, data transmission efficiency decreases due to increased data for authentication and charging, and so rapid control of the network becomes difficult. Also, the problem that control performance varies according to a network status may occur.

### SUMMARY

Accordingly, example embodiments of the present invention are provided to substantially obviate one or more problems due to limitations and disadvantages of the related art.

Example embodiments of the present invention provide a method for implementing a network using a distributed virtual switch, which can implement a mobile communication network flexibly and easily.

Example embodiments of the present invention also provide an apparatus performing the method for implementing a network using a distributed virtual switch.

Example embodiments of the present invention also provide a network system based on a distributed virtual switch, which is implemented using the method.

In some example embodiments, a method for implementing a network, performed in a network implementation apparatus, the method may comprise implementing network control functions as a plurality of virtual machines; grouping the plurality of virtual machines into several groups according a preconfigured policy; and implementing at least one virtual machine belonging to a same group in a same server having a virtualization structure based on a distributed virtual switch.

Here, the plurality of virtual machines are grouped into several groups according to at least one of a degree of confidentiality needed by each virtual machine, type information of an upper-level function of a control function performed by each virtual machine, amount of data exchanged between virtual machines, and a software platform of each virtual machine.

Here, each of the network control functions includes at least one of a data plane control function, a gateway proxy function, a base station proxy function, a mobility management function, a radio management function, a subscriber management function, a charging function, an application service function, and a database function.

Here, the method may further comprise obtaining information about properties of the network control functions; and obtaining information about amount of data exchanged between the plurality of virtual machines.

Here, the information about properties of the network control functions include at least one of information about confidentiality of the network functions, type information of upper-level functions of the network control functions, and information about platforms on which the network control functions operate.

Here, the plurality of virtual machines are grouped into several groups by referring to the information about properties of the network control functions or the information about amount of data exchanged between the plurality of virtual machines.

Here, the virtual machines are grouped into several groups so that amount of data exchanged between virtual machines belonging to a same group is maximized.

Here, the grouping the plurality of virtual machines into several groups according a preconfigured policy may further comprise selecting a pair of virtual machines having the smallest amount of data exchanged among virtual machines whose groups are not determined;

allocating a first virtual machine of the pair to a first group and a second virtual machine of the pair to a second group; selecting a third virtual machine having the largest average amount of data exchanged with virtual machines belonging to the first group, and selecting a fourth virtual machine having the largest average amount of data exchanged with virtual machines belonging to the second group among virtual machines whose groups are not determined; and allocating the third virtual machine to the first group.

In other example embodiments, a network implementation apparatus may comprise a processing part grouping a plurality of virtual machines performing a plurality of network control functions into several groups according to a preconfigured policy, and implementing at least one virtual machine belonging to a same group in a same server having a virtualization structure based on a distributed virtual switch; and a network interface transmitting the at least one virtual machine belong to the same group to the same server.

Here, the processing part groups the plurality of virtual machines into several groups according to at least one of a degree of confidentiality needed by each virtual machine, type information of an upper-level function of a control function performed by each virtual machine, amount of data exchanged between virtual machines, and a software platform of each virtual machine.

Here, each of the plurality of network control functions includes at least one of a data plane control function, a gateway proxy function, a base station proxy function, a mobility management function, a radio management function, a subscriber management function, a charging function, an application service function, and a database function.

Here, the processing part obtains information about properties of the plurality of network control functions and information about amount of data exchanged between the plurality of virtual machines through the network interface.

Here, the information about properties of the plurality of network control functions include at least one of information about confidentiality, type information of upper-level functions of the network control functions, and information about platforms on which the network control functions operate.

Here, the processing part groups the plurality of virtual machines into several groups by referring to the information about properties of the plurality of network control functions or the information about amount of data exchanged between the plurality of virtual machines.

Here, the processing part groups the plurality of virtual machines into several groups so that amount of data exchanged between virtual machines belonging to a same group is maximized.

In other example embodiments, a network system based distributed virtual switch may comprise a plurality of servers; at least one distributed virtual switch connecting the plurality of servers; and a plurality of virtual machines which perform network control function respectively and are connected through the at least one distributed virtual switch, wherein the plurality of virtual machines are grouped into several groups according to a preconfigured policy, and at least one virtual machine belonging to a same group is implemented in a same server among the plurality of servers.

According to the above-described method for implementing a network using distributed virtual switches, an apparatus performing the same, and a network system based on distributed virtual switches, control functions of a mobile communication network may be separated and implemented as a virtualization structure based on the distributed virtual switches. Therefore, the mobile communication network may be implemented flexibly, and controls and managements on it may be performed easily.

Also, a plurality of control functions may be grouped according to a preconfigured distribution policy, and control functions belonging to a same group are implemented in a same server as virtual machines. Accordingly, since traffics exchanged with external networks can be minimized, network loads may be reduced, and network performances may be enhanced.

### BRIEF DESCRIPTION OF DRAWINGS

Example embodiments of the present invention will become more apparent by describing in detail example embodiments of the present invention with reference to the accompanying drawings, in which:

FIGS. 1A and 1B are conceptual diagrams to explain networking infrastructures;

FIG. 2 is a conceptual diagram to explain a distributed virtual switch;

FIG. 3 is a conceptual diagram to illustrate a reference model of a mobile communication system;

FIG. 4 illustrates signaling functions and data forwarding functions as discriminated in the reference model illustrated in FIG. 3;

FIG. 5 is a conceptual diagram to explain a method for implementing a network using a distributed virtual switch according to an example embodiment of the present invention;

FIG. 6 is a block diagram to illustrate a mobile communication network system based on a distributed virtual switch according to an example embodiment of the present invention;

FIG. 7 is a flow chart to illustrate a method for implementing a network using a distributed virtual switch according to an example embodiment of the present invention;

FIG. 8 is a flow chart to illustrate a method for grouping virtual machines when a function distribution policy is set based on amount of exchanged data in a method for implementing a network using a distributed virtual switch according to an example embodiment of the present invention;

FIG. 9A is a conceptual diagram to explain an apparatus for implementing a network based on a distributed virtual switch; and

FIG. 9B is a block diagram to illustrate a function distribution server.

### DESCRIPTION OF EXAMPLE EMBODIMENTS

Example embodiments of the present invention are disclosed herein. However, specific structural and functional detail disclosed herein are merely representative for purposes of describing example embodiments of the present invention, however, example embodiments of the present invention may be embodied in many alternate forms and should not be construed as limited to example embodiments of the present invention set forth herein. Accordingly, while tie invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “on” or “below” another element, it can be directly on another element or intervening elements may be present.

It will be understood that, although the terms first, second, A, B, etc. may be used herein to describe various elements, these elements should not be limited by these terms. These terms are only used to distinguish one element from another. For example, a first element could be termed a second element, and similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures regardless of number of the figures.

In the following descriptions, virtualization technologies and mobile communication network technologies, which a method for network deployment using distributed virtual switch according to an example embodiment of the present invention is based on, will be explained first.

The virtualization is a technology that physical resources are logically divided and separated to be used as a plurality of independent resources, or physically independent multiple resource are logically grouped to be used as a single resource.

The virtualization technologies may include a network virtualization, a server virtualization, an operating system (OS) virtualization, a storage virtualization, a hardware virtualization, a service virtualization, and the like.

Among the virtualization technologies, a server virtualization is a technology for configuring multiple virtual machines in a single physical server, and operating the virtual machines by allocating processing power corresponding to performance of each virtual machine to each virtual machine. Also, it is a technology which has been already commercialized as multi-core processor technologies are advancing.

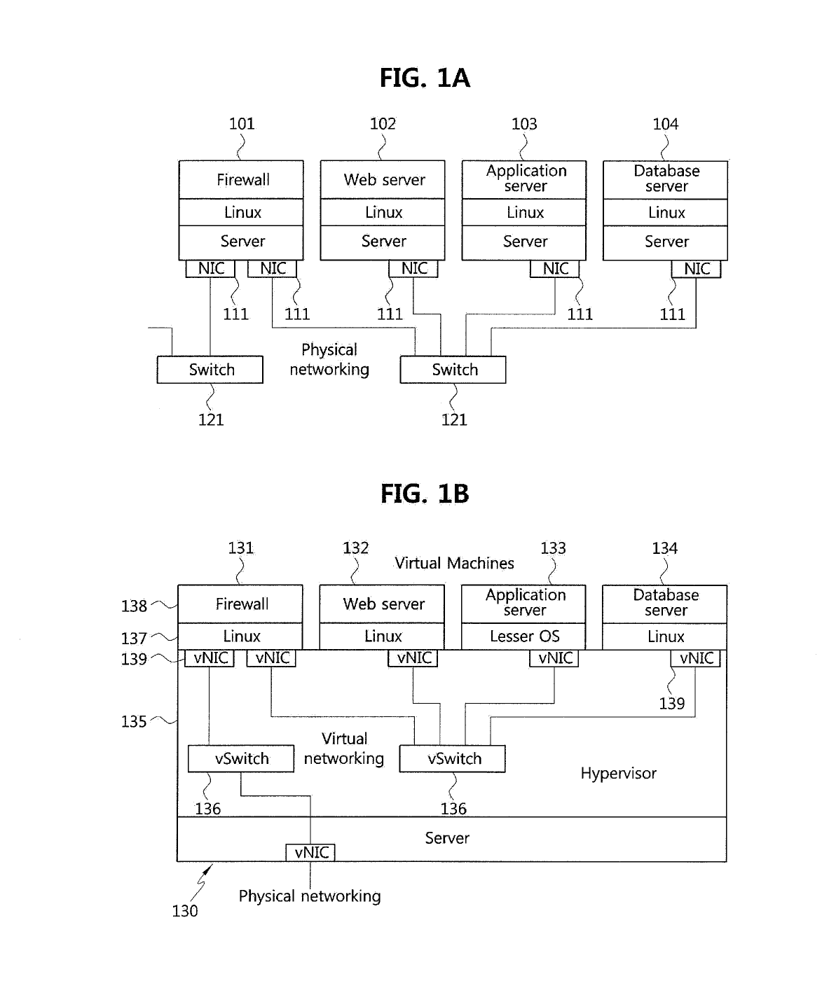

FIGS. 1A and 1B are conceptual diagrams to explain networking infrastructures. Specifically, FIG. 1A illustrates a conventional networking infrastructure, and FIG. 1B illustrates a virtualized networking infrastructure.

Referring to FIG. 1A, in the conventional network structure, each of servers 101 to 104 has a physically independent configuration to provide predefined specific services, and has at least one network interface (NIC) 111, connected to an external network switch 121, to perform communications with other servers.

The external network switch 121 may perform packet switching for packet communications between a plurality of servers 101 to 104.

In the conventional networking infrastructure illustrated in FIG. 1A, since the plurality of servers 101 to 104 are configured as physically independent components and communications between them are performed via the external network switch 121, there may be problems that functional expansion and management for them are difficult, and network implementation cost is high. Also, it is difficult to accommodate explosively increasing data traffic.

Meanwhile, in the virtualized networking infrastructure illustrated in FIG. 1B, a single physical server 130 comprises a plurality of virtual machines (VM) 131 to 134 each of which provides different services. In addition, information exchanges between the virtual machines 131 to 134 are performed via virtual switches 136 supported by a hypervisor 135.

Each of the virtual machines 131 to 134 may be configured with a separate operating system 137 and a set of applications 138. Also, although a part of hardware constituting the server 130 does not exist or is shared by multiple virtual machines, each of the virtual machines may identify its base hardware as it is not shared and as it exists completely.

Also, the hypervisor 135 performs a virtual monitor function or a virtual platform function enabling multiple operating systems to operate on the single server 130, and supports communications between endpoints of the virtual machines.

In other words, the hypervisor 135 may generate at least one virtual network interface (vNIC) 139 for each virtual machine, and the generated virtual network interface 139 may operate as a physical network interface for each of the virtual machines 131 to 134. Also, the hypervisor 135 supports dynamic configuration of virtual network through the virtual switch 136 enabling communications between the virtual machines 131 to 134. Also, the hypervisor 135 supports efficient communications between the virtual machines within the hypervisor 135 and efficient communications with external physical networking infrastructures by connecting a physical network interface of the server 130 to logical components of the hypervisor 135.

As described above, in the virtualized networking infrastructure, since communications between the virtual machines 131 to 134 are performed in the same server 130, communication speed is determined according to not external networking environments but only memory access speed within the server, so that superior communication speed can be obtained as compared with the conventional networking infrastructure.

On the other hand, in order to additionally advance the above-described virtualized networking infrastructure, a technology of a distributed virtual switch has appeared.

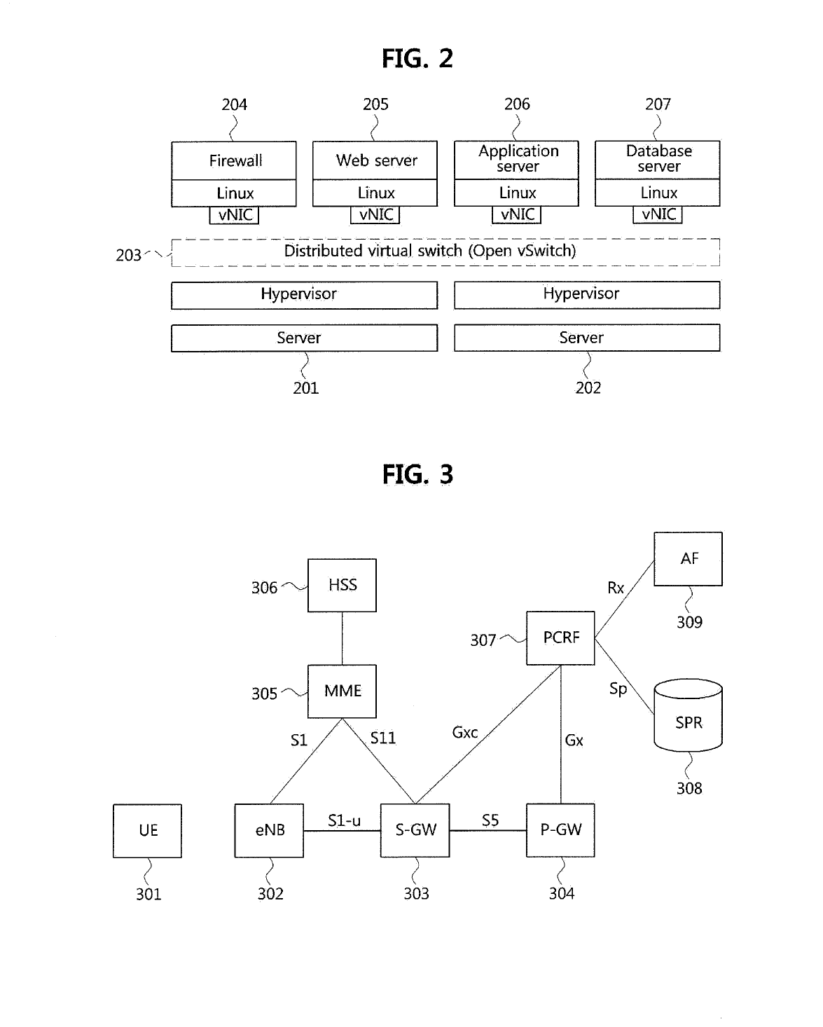

FIG. 2 is a conceptual diagram to explain a distributed virtual switch.

Referring to FIG. 2, a distributed virtual switch 203 is based on a technology which advances from a virtual switch illustrated in FIG. 1B, and makes connections between servers 201 and 202 possible by using a method of making a lower structure comprising the servers 201 and 202 transparent to an upper structure.

That is, the distributed virtual switch 203 is based on a concept that virtual switches of the server 201 comprising virtual machines 204 and 205 and the server 202 comprising virtual machines 206 and 207 are transparently connected to each other. In this case, a virtual switch located in a server (that is, the server 201) can be transparently connected to a virtual switch located in another server (that is, the server 202). Therefore, a migration of a virtual machine between servers may become simplified.

Hereinafter, a mobile communication network will be explained briefly. For example, a Long Term Evolution (LTE) system will be explained.

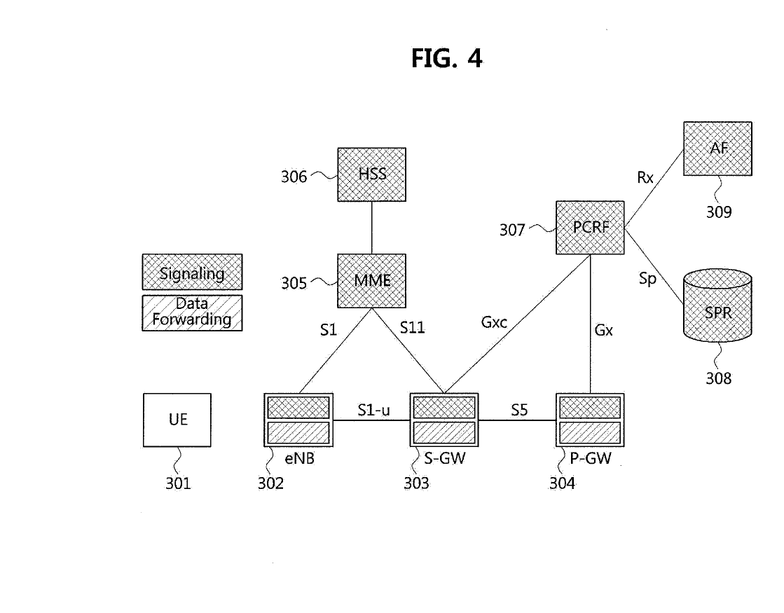

FIG. 3 is a conceptual diagram to illustrate a reference model of a mobile communication system. FIG. 3 illustrates an example of a LTE network system. Also, FIG. 4 illustrates signaling functions and data forwarding functions as discriminated in the reference model illustrated in FIG. 3.

Referring to FIG. 3 and FIG. 4, the LTE network reference model may generally comprise LTE entities corresponding to an access network and Evolved Packet Core (EPC) entities corresponding to a core network.

The LTE entities comprise an UE 301 and an eNB 302. Also, the EPC entities comprise a Serving Gateway (S-GW) 303, a Packet Data Network Gateway (P-GW) 304, a Mobility Management Entity (MME) 305, a Home Subscriber Server (HSS) 306, a Policy Control and Charging Rule Function (PCRF) 307, a Subscription Profile Repository (SPR) 308, and an Application Function (AF) 309.

The UE 301 is corresponding to a user terminal, and connects to an eNB 302 via an LTE-Uu radio interface.

The eNB 302 provides the UE 301 with the radio interface, and supports radio resource management functions such as a radio bearer control, a radio acceptance control, a dynamic radio resource allocation, a load balancing, and an inter-cell interference control.

The S-GW 303 is an endpoint of an Evolved-Universal Terrestrial Radio Access Network (E-UTRAN) and the EPC, and performs a role of an anchoring point during an inter-eNB handover and an inter-3GPP system handover.

The P-GW 304 connects the UE 301 to an external Packet Data Network (PDN), and performs a packet filtering function. Also, the P-GW 304 assigns an IP address to the UE 301, performs an IP routing and forwarding function, and performs a service data flow or a user-based charging function.

The MME 305 is a control plane entity of the E-UTRAN, and performs functions such as a user authentication, a roaming function, state managements including an EPS connection management (ECM) and an EPS Mobility Management (EMM), an Evolved Packet System (EPS) bearer management, and so on.

The HSS 306 performs a central database function storing user profiles, and provides the MME 305 with user authentication information and user profile.

The PCRF 307 is a policy and charging management entity, and performs a policy control determination and a charging management function. The rule generated in the PCRF 307 is delivered to the P-GW 304.

The SPR 308 provides the PCRF 307 with user information and related information. The PCRF 307 receives the information from the SPR 308, performs a user-based policy, and generates a charging rule.

On the other hand, the LTE network reference model may be classified into control plane function entities and data plane function entities according to their functions. The control plane function entities may include the MME 305, the PCRF 307, the HSS 306, etc. and the data plane function entities may include the eNB 302, the S-GW 303, the P-GW 304, etc.

Also, standard protocols are used to perform communications between control plane function entities, between data plane function entities, and between control plane function entities and data plane function entities. For example, the MME 305 and the eNB 302 are connected through a S1 interface, and communicate with each other using a S1AP protocol. Also, the MME 305 and the S-GW 303 are connected through a S11 interface, and communicate with each other using a GTP-c protocol. Protocols between functional entities are determined from standardization.

As described above, the control plane function entities are functional elements responsible for signaling, and perform signaling for exchanging control information between entities in order to perform resource controls for service configuration, authentications on user and terminal, charging, etc. The data plane function entities (the S-GW 303, P-GW 304, and the eNB 302) may also participate the above signaling procedure. That is, the S-GW 303, the P-GW 304, and the eNB 302 may perform the data switching functions and the signaling functions at the same time.

The signaling functions performed by the S-GW 303, the P-GW 304, and the eNB 302 are implemented as distributed in locations identical to installation positions of network apparatuses performing the corresponding functions, and other control functions performed by other control plane function entities are implemented as performed in at least one server. Therefore, communications between entities are performed via a network. However, there may be various shortcomings according to a network deployment and a communication environment.

For example, flexibility in network deployment may be reduced. That is, since a network should be designed, and positions of servers and data forwarding apparatuses should be determined in consideration of signaling paths, various aspects including functions of network apparatuses and installation positions of network apparatuses should be considered. Accordingly, the network cannot be implemented flexibly.

Also, additional signaling protocols are necessary for information exchanges between function entities. The signaling protocols are necessary for information exchanges between function entities located distributively. However, when function entities are distributed, there may be shortcomings that overheads of encoding/decoding information elements exchanged between the entities as well as the information elements themselves are demanded.

Also, since confidential information such as authentication information and user profiles are exchanged through the signaling, processes related to security, such as encryption, etc., should be additionally demanded. Even though the processes related to security are performed, security cannot be completely guaranteed. Also, control overheads due to the additional security processes and packet overheads due to data encryption/decryption may be increased. Also, since a large amount of data for authentication and charging are exchanged in the network, data transmission efficiency of the network decreases and so prompt control of the network becomes difficult. Accordingly, the problem that control performance varies according to a status of the network occurs.

In order to overcome the above-described shortcomings of the mobile communication network, a method for network deployment using distributed virtual switch according to an example embodiment of the present invention provides a method for flexibly implementing control functions of the mobile communication network in a single server or a plurality of servers without regard to physical positions of network apparatuses. Therefore, costs of network construction and network management may be decreased so that mobile virtual network operators (MNVOs) as well as the conventional network operators can implement a virtual mobile communication network with a low cost.

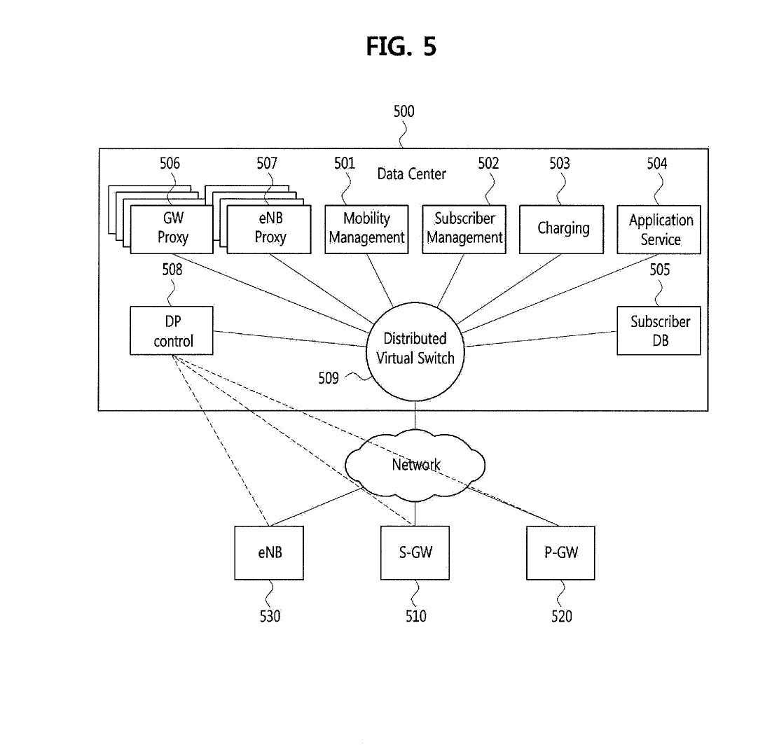

Hereinafter, a method for implementing a network using a distributed virtual switch, an apparatus for the same, and a system based on distributed virtual switch, according to an embodiment of the present invention, will be explained in detail by referring to FIGS. 5 to 9.

FIG. 5 is a conceptual diagram to explain a method for implementing a network using a distributed virtual switch according to an example embodiment of the present invention, and illustrates an upper-level network conceptual diagram to explain the method according to an example embodiment of the present invention with easiness.

As illustrated in FIG. 5, in the present invention, signaling entities of a mobile communication network may be implemented as located in a virtualization based data center 500. Here, the virtualization based data center 500 may be configured with a single physical server, or a plurality of physical servers connected through a distributed virtual switch.

That is, in the present invention, control functions and data forwarding function of a mobile communication network are separated. The control functions are implemented as integrated into the virtualization based data center 500, so that control functions such as signaling, etc. may be performed in the data center 500 and network apparatuses may perform only data forwarding functions. Thereby, the above-described problem due to heavy signaling can be resolved and a mobile communication network may be implemented flexibly and with a low cost.

Although various control function entities are implemented respectively as separate servers in the conventional mobile communication network, in the present invention, the various control entities required for mobile communication services such as a mobility management 501, a subscriber management 502, a charging 503, an application service 504, a subscriber database 505, etc. are implemented in the data center 500.

Here, each of the various control functions 501 to 505, implemented in the data center 500, may be implemented as a virtual machine (VM). Also, each virtual machine may be implemented to use as many processing resources as it needs.

Also, in addition to the above-described control functions, proxy functions 506 and 507 of network apparatuses and a data plane (DP) control function 508 may be implemented in the data center 500, and such the functions may also be implemented as virtual machines.

In other words, signaling functions performed in the conventional network apparatuses such as the GWs 510 and 520 and the eNB 530 are added to the data center 500, so that signaling overhead may be reduced by accommodating the signaling performed between the server and the network apparatuses in the data center 500 based on the distributed virtual switch 509.

Also, data plane control function for controlling data forwarding apparatuses according to final determinations made based on signaling between servers may perform resource controls such as resource allocation for providing services on a data path by transmitting commands to the data forwarding apparatuses, and perform a function for receiving information about various events generated in the data forwarding apparatuses. Here, information exchanges with various data forwarding apparatuses 510, 520, and 530 located in the external of the data center 500 may be performed via a data plane control function entity 508. The communications between the data plane control function entity 508 and the external data forwarding apparatuses 510, 520, and 530 are logically direct communications. However, the communications are physically performed via the distributed virtual switch 509 located in the data center 500.

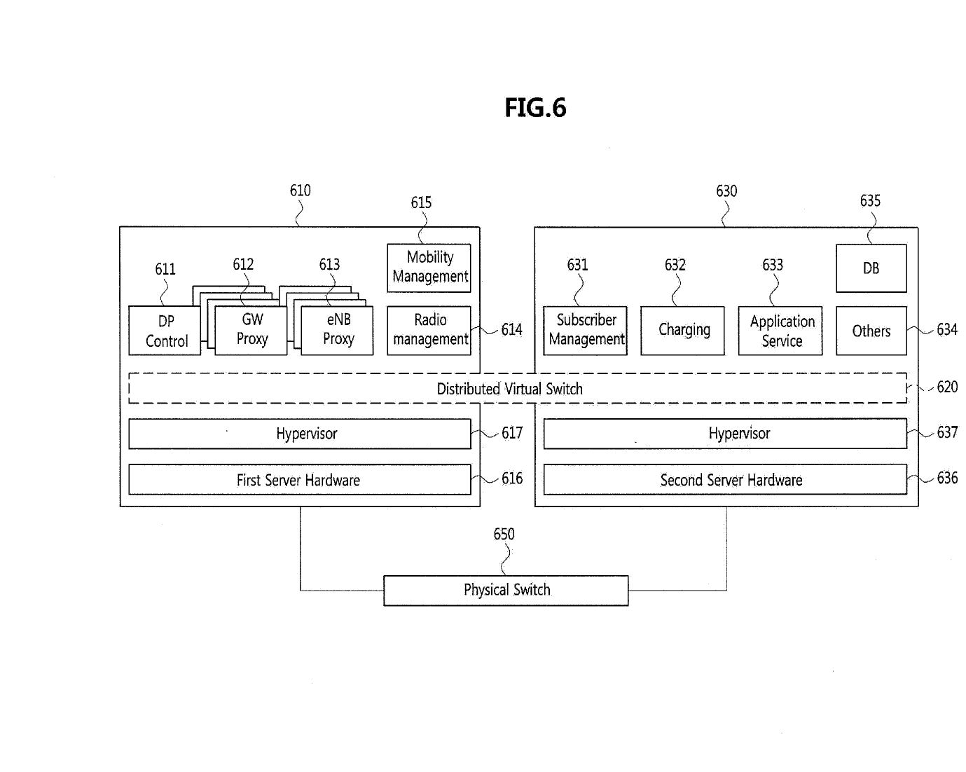

FIG. 6 is a block diagram to illustrate a mobile communication network system based on a distributed virtual switch according to an example embodiment of the present invention.

In FIG. 6, an example of the mobile communication network system based on a distributed virtual switch, implemented using two physical servers 610 and 630, is illustrated. However, the method according to the present invention is not restricted to the example using two servers, and may be applied to examples using a single server or more than two servers.

Referring to FIG. 6, the mobile communication network system based on a distributed virtual switch according to an embodiment of the present invention may be applied to a virtualization structure in which a first server 610 and a second server 630 are connected through a distributed virtual switch 620. Here, the first server 610 and the second server 630 may be included in the data center 500 illustrated in FIG. 5.

As shown in FIG. 6, the conventional network control functions, management functions, and data plane control functions may be distributed to a plurality of virtualization based servers (for example, the servers 610 and 630), and implemented as virtual machines.

In FIG. 6, an example, in which network control function entities 611 to 615 performing network control functions are implemented as virtual machines in the first server 610 and service function entities 631 to 635 responsible for service processing functions treating service requirements such as user authentication and charging and for processing user information are implemented as virtual machines in the second server 630, is illustrated.

Each of the servers 610 and 630 may hierarchically comprise physical hardware resources 616 or 636, hypervisors 617 and 637, a distributed virtual switch 620, and a plurality of virtual machines 611 to 615, and 631 to 635.

Each of hardware resources 616 and 636 for each of the servers 610 and 630 means hardware components for each server, and may include a processor, a memory, a storage device, and a network interface.

The hypervisors 617 and 637, as described above, perform functions of a virtual monitor or a virtual platform to make a plurality of operating systems operate simultaneously in each server, and supports communications between virtual machines.

The distributed virtual switch 620 performs a function for combining the first server 610 and the second server 630 transparently, and performs a function of a virtual switch for data communications between virtual machines existing in each server or between virtual machines existing in different servers.

A plurality of virtual machines 611 to 615 and 631 to 635 may comprise a set of operating systems and a set of applications, and be configured to perform different functions. Here, operating systems included in each of the virtual machines 611 to 615 and 631 to 635 may be identical to or different from those of other virtual machines.

In the present invention, a data plane control function 611, GW proxy functions 612, eNB proxy functions 613, a radio management function 614, and a mobility management function 615 of a mobile communication network may be implemented respectively as virtual machines in the first server 610. Also, a subscriber management function 631, a charging function 632, an application service function 633, other management functions 634, and a database function 635 may be implemented respectively as virtual machines in the second server 530. Here, the GW proxy functions 612 and the eNB proxy functions 613 may be configured with a plurality of virtual machines according to the number of physical GW apparatuses and eNB apparatuses.

Communications between the virtual machines 611 to 615 in the first server 610 and communication between the virtual machines 631 to 635 in the second server 630 may be performed via the distributed virtual switch 620. Meanwhile, communications between a virtual machine in the first server 610 and a virtual machine in the second server 630 may be performed via a physical switch 650 connected between the first server 610 and the second server 630.

Also, communications between a network apparatus located outside the servers 610 and 630 and the virtual machines 611 to 615 and 631 to 635 located in the servers 610 and 630 may be performed via the physical switch 650.

Signaling related to services and signaling related to network control, among signaling performed in a mobile communication network, are performed independently. Also, the correlation between signaling function entities related to services and the correlation between signaling function entities related to network control are high, and so the amount of data exchanged between the related entities is large. Accordingly, in consideration of the above characteristics, function entities are distributed to the first server 610 or the second server 630 according to properties of their signaling as shown in FIG. 6. By distributing a plurality of function entities according to properties of their signaling, amount of data exchanged through a physical switch can be minimized and so control performances may be enhanced.

The virtual machines may be grouped according to various methods besides the above-described distribution method illustrated in FIG. 6, so that control performances can be enhanced.

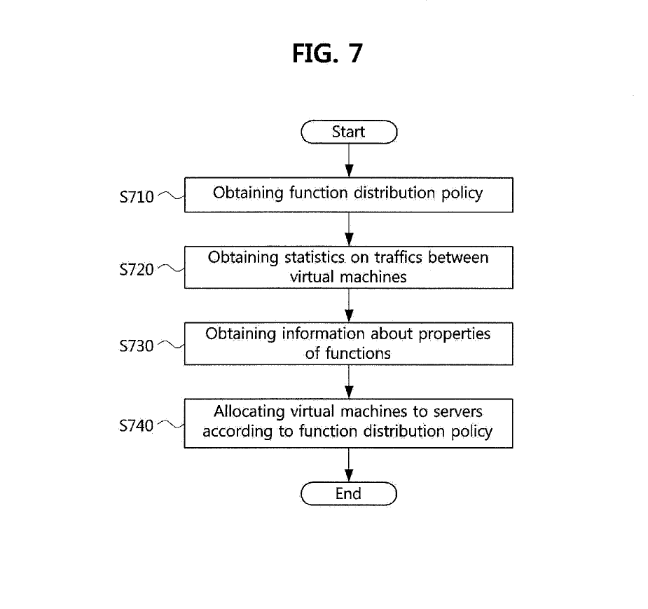

FIG. 7 is a flow chart to illustrate a method for implementing a network using a distributed virtual switch according to an example embodiment of the present invention, and the method may be performed by a function distribution server.

In FIG. 7, control function entities of a mobile communication network are assumed to be implemented as virtual machines based on a virtualization structure. The control function entities are grouped into several groups, and distributed to multiple servers.

Referring to FIG. 7, a function distribution server may obtain a function distribution policy (S710). Here, the function distribution policy may be criteria for grouping a plurality of function entities or a plurality of virtual machines performing functions, configured by a network operator, and stored in a distribution policy database or a distribution policy server.

The function distribution policy may be set based on a degree of confidentiality needed for signaling. That is, information such as user information and charging information, confidentiality of which should be maintained, may be exchanged between virtual machines. In this case, it is desirable that outflows to external networks of such the information should be minimized. Therefore, if virtual machines processing such the information are grouped into a specific group and implemented in the same server, confidentiality of them may be enhanced. Also, if it is necessary to maintain confidentiality according to a secret class, virtual machines processing information having a similar secret class may be grouped into the same group and implemented in the same server, so that efficiencies of maintaining confidentiality can be enhanced.

Also, the function distribution policy may be set based on an upper-level function type of a control function performed by a virtual machine. That is, virtual machines having the same upper-level functions in their function entities may be grouped into the same group, and implemented in the same server, so that efficiencies of management on servers can be enhanced.

Also, the function distribution policy may be set based on amount of data exchanged between virtual machines performing function entities. In order to minimize traffics transmitted to an external switch for inter-server communications, when a plurality of virtual machines exist, amount of data exchanged between the virtual machines may be measured, and the virtual machines may be grouped according to the measured amount of data. Here, it is desirable that the virtual machines are grouped to minimize amount of data exchanged between groups.

Also, the function distribution policy may be set based on types of software platforms such as operating system, etc. Among function entities of a mobile communication network, function entities operating on software platforms may be restricted by software environments on which they operate. Thus, it is desirable that function entities are grouped in consideration of their platforms such as operating system, etc.

Also, the function distribution policy may be set according to heuristic information based on accumulated information, so that it may be set by selectively combining at least one of the above-described policies.

Re-referring to FIG. 7, the function distribution server may obtain statistics on traffics between virtual machines (S720). Here, statistics on traffics may be collected using the distributed virtual switch, and the collected information may comprise statistic information for each pair of the virtual machines.

Also, the function distribution server may obtain information about properties of a plurality of control functions (S730). Here, the information about properties of control functions may be obtained from function entities performing control functions of a mobile communication network, and the information may include at least one of information about confidentiality of the network functions, type information of upper-level functions of the network control functions, and information about platforms on which the network control functions operate.

For convenience of explanation, an example in which the steps S710, S720, and S730 are performed sequentially is illustrated in FIG. 7. However, the above steps may be performed without a specific order.

Then, the function distribution server may group a plurality of virtual machines by referring to statistics on traffics and/or information of properties of functions according to the obtained distribution policy, and allocate at least one virtual machine belonging to each group to a server corresponding to each group (S740). Here, a plurality of virtual machines or function entities may be configured with software performing corresponding function, and the function distribution server may provide the corresponding server with the software performing the function entity according to the result of the allocation.

For example, when the function distribution policy is based on amount of data exchanged between virtual machines, software may be allocated to each server by referring to the statistics on traffics so that average amount of data exchanged between virtual machines within each server is maximized.

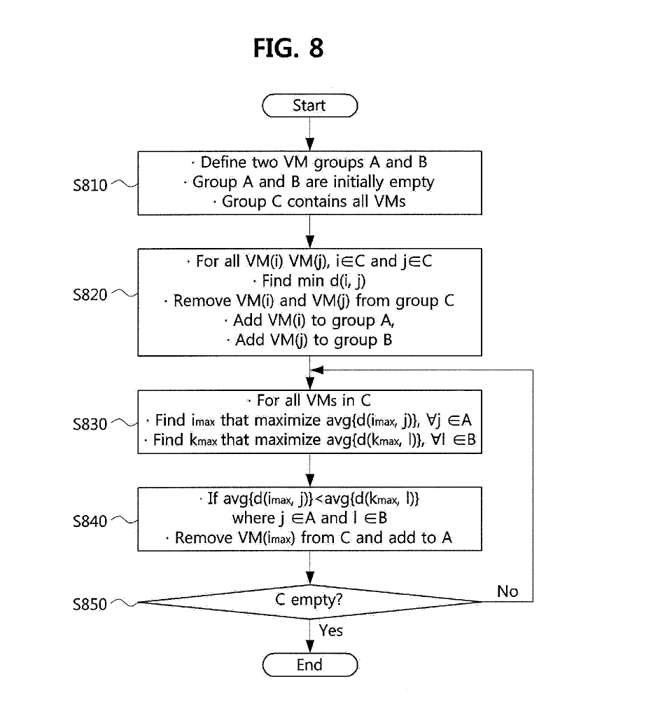

FIG. 8 is a flow chart to illustrate a method for grouping virtual machines when a function distribution policy is set based on amount of exchanged data in a method for implementing a network using a distributed virtual switch according to an example embodiment of the present invention. In FIG. 8, an example in which virtual machines performing functions are grouped into two groups, and each group is allocated to different server is illustrated. The method depicted in FIG. 8 may be performed by a function distribution server.

In FIG. 8, when M virtual machines exist, VM(i) means an i^{th} virtual machine and VM(j) means a j^{th} virtual machine. Also, d(i,j) means amount of data exchanged between the i^{th} virtual machine and the i^{th} virtual machine.

Referring to FIG. 8, two virtual machine groups may include a group A and a group B. Here, initially, each of the group A and the group B does not have any virtual machines. Also, a group including all virtual machines whose group is not yet determined is defined as a group C (S810).

Then, a pair of virtual machines VM(i) and VM(j), having the smallest amount of data exchanged between them, are selected among all virtual machines belonging to the group C. Then, the selected pair of virtual machines VM(i) and VM(j) are removed from the group C, and each of the pair of VM(i) and VM(j) is included in the group A and the group B, respectively (S820). That is, VM(i) is added to the group A, and VM(j) is added to the group B. Here, each of i and j means an index of a virtual machine included in the group C, and may be a natural number.

Then, among all virtual machines remaining in the group C, a virtual machine VM(iₘₐₓ) which can maximize average amount of data exchanged with all virtual machines belonging to the group A and a virtual machine VM(kₘₐₓ) which can maximize average amount of data exchanged with all virtual machines belonging to the group B are selected (S830). Also, avg{d(i,j)} means average amount of data exchanged between the i^{th} virtual machine and the i^{th} virtual machine.

Then, an average amount of data exchanged between the selected virtual machine VM(iₘₐₓ) and all virtual machines belonging to the group A and an average amount of data exchanged between the selected virtual machine VM(kₘₐₓ) and all virtual machines belonging to the group B are calculated and compared. After then, a virtual machine having a smaller average amount of exchanged data is selected among VM(iₘₐₓ) and VM(kₘₐₓ), and then the selected virtual machine is removed from the group C and added to the group A (S840).

The average amount of exchanged data in the step S840 may be calculated using a below equation 1.

$$d ( {i}_{max} , j ) = {max}_{i ∈ C} [ {\sum }_{j ∈ A} \frac{d ( i , j )}{n ( A )} ] \\ d ( {k}_{max} , l ) = {max}_{k ∈ C} [ {\sum }_{l ∈ A} \frac{d ( k , l )}{n ( B )} ] \qquad [ Equation 1 ]$$

In the equation 1, i and k mean indexes of virtual machines belonging to the group C. j means an index of a virtual machine belonging to the group A, and l means an index of a virtual machine belonging to the group B. Also, n(A) means the number of virtual machines belonging to the group A, and n(B) means the number of virtual machines belonging to the group B.

Then, it is determined whether any virtual machine exists in the group C (S850). If a virtual machine exists in the group C, the steps S830 to S840 are repeated.

The example depicted in FIG. 8 illustrates a case in which a plurality of virtual machines are grouped into two groups. However, the method may be applied to a case in which a plurality of virtual machines are grouped into more than two groups.

Also, although an example in which a plurality of virtual machines are grouped so as to maximize average amount of data exchanged between virtual machines implemented in a same server in FIG. 8, other policies beside the policy of the example in FIG. 8 may be applied to the grouping.

For example, at least one pair of virtual machines having the smallest amount of exchanged data is selected among virtual machines belonging to the group C and the group A. Then, a virtual machine belonging to a pair having the largest amount of exchanged data among the selected pairs may be removed from the group C and added to the group A. That is,

$$d ( {i}_{max} , j ) = {max}_{i ∈ C} [ {min}_{j ∈ A} d ( i , j ) ] .$$

Alternatively, at least one pair of virtual machines having the largest amount of exchanged data is selected among virtual machines belonging to the group C and the group A. Then, a virtual machine belonging to a pair having the largest amount of exchanged data among the selected pairs may be removed from the group C and added to the group A. That is,

$$d ( {i}_{max} , j ) = {max}_{i ∈ C} [ {max}_{j ∈ A} d ( i , j ) ] .$$

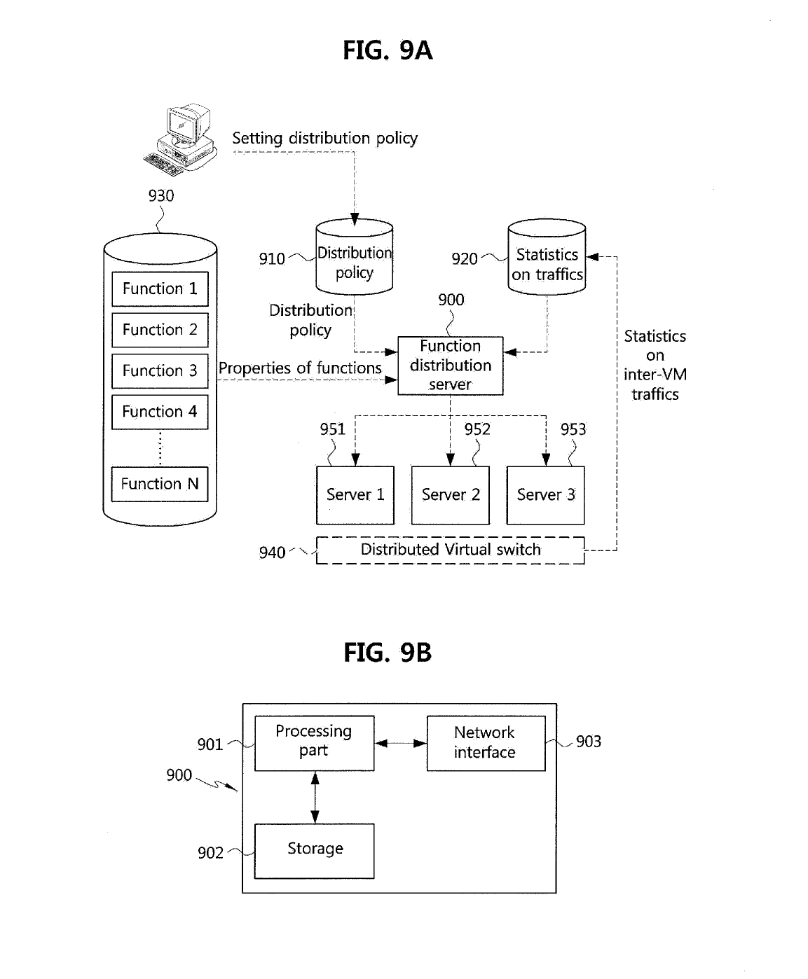

FIG. 9A is a conceptual diagram to explain an apparatus for implementing a network based on a distributed virtual switch, and FIG. 9B is a block diagram to illustrate a function distribution server allocating control functions of a mobile communication network to three physical servers in order to construct a mobile communication network environment in which the three servers are connected through the distributed virtual switch.

Referring to FIG. 9A, the function distribution server 900 may allocate control functions of a mobile communication network according to a distribution policy, statistics on traffics, and information about properties of functions.

The distribution policy may be set variously by a system operator, and stored in a distribution policy database 910 or a distribution policy server 910. For example, a distribution policy may be set by selectively combining amount of data exchanged between virtual machines, similarity of functions, degree of confidentiality, secret grades, types of software platforms, and so on.

The distribution policy may be provided to the function distribution server 900 according to a preconfigured method. For example, it may be provided to the function distribution server 900 automatically when the distribution policy is changed. Alternatively, it may be provided to the function distribution server 900 according to control of a system operator or a network operator.

The statistics on traffics may be collected in the distributed virtual switch 940, and the collected information may include statistic information for each pair of virtual machines. Also, the collected information may be stored in a traffic statistics server 920 or a traffic statistics database 920.

The information about properties of functions may be obtained from functional entities of a network, or obtained from software performing the functions. The function software which is target of allocation may be stored in the storage 930, and then provided to a corresponding to server allocated by the function distribution server 900 when necessary. Here, the function distribution server 900 may store information about properties of functions corresponding to each function software when the function software is stored. The information about properties of functions may include a degree of confidentiality of each function, a type of upper-level function of each function, information about a software platform for each function, and so on.

The function distribution server 900 obtains a distribution policy from the distribution policy database, and allocates function software to one of the three servers 951 to 953 according to the obtained distribution policy by referring to statistics on traffics and/or information about properties of functions. For example, when the function distribution policy is set based on amount of data exchanged between virtual machines, function software may be allocated to each server by referring to the statistics on traffics so that average amount of data exchanged between virtual machines within each sever is maximized.

Function software allocated to the servers 951 to 953 may be implemented as virtual machines in the corresponding server.

Also, even after the function software is allocated, the function distribution server 900 may modify allocation of each function software (or, a virtual machine performing each function) according to statistics on traffics and/or distribution policy changing in real-time.

Referring to FIG. 9B, the function distribution server 900 may comprise a processing part 901, a storage 902, and a network interface 903.

As described above, the processing part 901 may perform a function for allocating function software (or, virtual machines) according to a distribution policy, statistics on traffics, and information about properties of functions.

The storage 902 may store at least one function software performing control functions of a mobile communication network, and program codes comprising instructions for performing a method for implementing a network based on a distributed virtual switch according to an example embodiment of the present invention.

The network interface 903 performs communications with the distribution policy server 910, the traffic statistics server 920, etc. according to control of the processing part 901, and transmits function software to the allocated corresponding server.

Meanwhile, the method for implementing a network based on a distributed virtual switch according to an embodiment of the present invention may be implemented as program instructions executable by computers, and then recorded on a computer readable medium. The computer readable medium may include a program instruction, a data file, a data structure, or a combination thereof. The program instructions recorded on the computer readable medium may be designed and configured specifically for the present invention or can be publically know and available to those who are skilled in the field of software. Examples of the computer readable medium may include a hardware device such as a Solid State Disk (SSD), a hard disk, a floppy disk, a magnetic tape, a CD-ROM, a DVD, a floptical disk, a magneto-optical media, a ROM, a RAM, or a flash memory, which is specifically configured to store and execute the program instructions. The medium may also be a transmission media such as an optical cable, a metal wire, a waveguide, etc. including a carrier through which signal indicating program instructions and data structures is transmitted. Examples of the program instructions can include machine codes made by, for example, a compiler, as well as high-level language codes executable by a computer with an interpreter. The above exemplary hardware devices can be configured to operate as one or more software modules in order to perform the operation in an exemplary embodiment, and the opposite is also possible.

While the example embodiments of the present invention and their advantages have been described in detail, it should be understood that various changes, substitutions and alterations may be made herein without departing from the scope of the invention.

What is claimed is:

1. A method for implementing a network, performed in a network implementation apparatus, the method comprising:
implementing network control functions as a plurality of virtual machines;
grouping the plurality of virtual machines into several groups according a preconfigured policy; and
implementing at least one virtual machine belonging to a same group in a same server having a virtualization structure based on a distributed virtual switch.

2. The method of claim 1, wherein the plurality of virtual machines are grouped into several groups according to at least one of a degree of confidentiality needed by each virtual machine, type information of an upper-level function of a control function performed by each virtual machine, amount of data exchanged between virtual machines, and a software platform of each virtual machine.

3. The method of claim 1, wherein each of the network control functions includes at least one of a data plane control function, a gateway proxy function, a base station proxy function, a mobility management function, a radio management function, a subscriber management function, a charging function, an application service function, and a database function.

4. The method of claim 1, further comprising:
obtaining information about properties of the network control functions; and
obtaining information about amount of data exchanged between the plurality of virtual machines.

5. The method of claim 4, wherein the information about properties of the network control functions include at least one of information about confidentiality of the network functions, type information of upper-level functions of the network control functions, and information about platforms on which the network control functions operate.

6. The method of claim 4, wherein the plurality of virtual machines are grouped into several groups by referring to the information about properties of the network control functions or the information about amount of data exchanged between the plurality of virtual machines.

7. The method of claim 1, wherein the virtual machines are grouped into several groups so that amount of data exchanged between virtual machines belonging to a same group is maximized.

8. The method of claim 1, wherein the grouping the plurality of virtual machines into several groups according a preconfigured policy further comprises:
selecting a pair of virtual machines having the smallest amount of data exchanged among virtual machines whose groups are not determined;
allocating a first virtual machine of the pair to a first group and a second virtual machine of the pair to a second group;
selecting a third virtual machine having the largest average amount of data exchanged with virtual machines belonging to the first group, and selecting a fourth virtual machine having the largest average amount of data exchanged with virtual machines belonging to the second group among virtual machines whose groups are not determined; and
allocating the third virtual machine to the first group.

9. A network implementation apparatus comprising:
a processing part grouping a plurality of virtual machines performing a plurality of network control functions into several groups according to a preconfigured policy, and implementing at least one virtual machine belonging to a same group in a same server having a virtualization structure based on a distributed virtual switch; and
a network interface transmitting the at least one virtual machine belong to the same group to the same server.

10. The apparatus of claim 9, wherein the processing part groups the plurality of virtual machines into several groups according to at least one of a degree of confidentiality needed by each virtual machine, type information of an upper-level function of a control function performed by each virtual machine, amount of data exchanged between virtual machines, and a software platform of each virtual machine.

11. The apparatus of claim 9, wherein each of the plurality of network control functions includes at least one of a data plane control function, a gateway proxy function, a base station proxy function, a mobility management function, a radio management function, a subscriber management function, a charging function, an application service function, and a database function.

12. The apparatus of claim 9, wherein the processing part obtains information about properties of the plurality of network control functions and information about amount of data exchanged between the plurality of virtual machines through the network interface.

13. The apparatus of claim 12, wherein the information about properties of the plurality of network control functions include at least one of information about confidentiality, type information of upper-level functions of the network control functions, and information about platforms on which the network control functions operate.

14. The apparatus of claim 12, wherein the processing part groups the plurality of virtual machines into several groups by referring to the information about properties of the plurality of network control functions or the information about amount of data exchanged between the plurality of virtual machines.

15. The apparatus of claim 9, wherein the processing part groups the plurality of virtual machines into several groups so that amount of data exchanged between virtual machines belonging to a same group is maximized.

16. A network system based distributed virtual switches, the network system comprising:
a plurality of servers;
at least one distributed virtual switch connecting the plurality of servers; and
a plurality of virtual machines which perform network control function respectively and are connected through the at least one distributed virtual switch,
wherein the plurality of virtual machines are grouped into several groups according to a preconfigured policy, and at least one virtual machine belonging to a same group is implemented in a same server among the plurality of servers.
